(19) United States
(12) Patent Application Publication
(10) Pub. No.: US 2014/0073249 A1
(43) Pub. Date: Mar. 13, 2014

(54) SYSTEM AND METHOD FOR MANAGING HARDWARE COMMUNITY

(71) Applicant: Cardo Systems Inc., Pittsburgh, PA (US)

(72) Inventors: Abraham Glezerman, Tel Aviv (IL); Yossef Twina, Rosh Ha'ayin (IL); Abraham Avi Moato, Rishon Lezion (IL)

(73) Assignee: Cardo Systems Inc., Pittsburgh, PA (US)

(21) Appl. No.: 13/883,957

(22) PCT Filed: Oct. 24, 2012
(86) PCT No.: PCT/IL2012/050420

§ 371 Date: May 7, 2013

(30) Foreign Application Priority Data
Oct. 31, 2011 (IL) 216072

(51) Int. Cl. H04W 4/00; H04W 8/00

(52) U.S. Cl. CPC H04W 4/008; H04W 8/005
USPC 455/41.2

(57) ABSTRACT

The invention relates to a method for permitting communication between a first Bluetooth-enabled device and one or more additional Bluetooth enabled devices, the method comprises performing of a coupling procedure that causes storage at said first device of the Bluetooth Device Address (BD Addr) of each of the one or more devices with which said first device needs to be permitted to communicate.

### FIELD OF THE INVENTION

The present invention relates to the management of Bluetooth communication devices. More particularly, the invention relates to the management of Bluetooth devices used in group activities, such as sport and leisure activities.

### BACKGROUND OF THE INVENTION

In many group activities the ability to communicate between two or more people engaging in them has become an important factor with the advent of radio communication. Illustrative examples of such group activities are motorcycle and bicycle riders, who engage in group tours and other activities, skiers, etc. Additionally, when motorcycles are involved, for instance, communication is important—and difficult—also between the driver and the person riding with him.

Communications of this type have been rendered much more convenient and easy with the advent of Bluetooth technology, and a number of different Bluetooth headsets are available on the market, which permit communication between different people engaged in group activities. Bluetooth technology, however, in spite of its many advantages, has the disadvantage of requiring a so-called “pairing” step, i.e., the exchange of data between two Bluetooth-enabled devices, to allow them to communicate between them. This requirement results in the problem that pairing must be effected on the spot, physically between the participants in the group activity, before they can communicate among them. Moreover, in existing commercial products pairing can be effected only between two devices, which limits their applicability to group activities. Pairing also takes a long time.

It is therefore obvious that it would be highly desirable to provide a device, a system and a method, which overcome the above-mentioned disadvantages of the prior art. It is an object of the present invention to provide such a device, as well as a system supporting its extended use and a method therefor.

It is a further object of the invention to provide a method and system which allow users of Bluetooth communication devices to preselect a plurality of other devices to which they will be paired, before they are physically located in the same location.

It is another object of the invention to provide a device, system and method for which a plurality of users are able to communicate among themselves, such that each member of the group is capable of communicating with any other member thereof, without the need to perform a pairing procedure.

It is yet another object of the invention to provide a system that allows the owner of a Bluetooth communication device to manage his connections with other devices, without the need to be in the vicinity of said other devices.

Other objects and advantages of the invention will become apparent as the description proceeds.

### SUMMARY OF THE INVENTION

In one aspect the invention is directed to a method for permitting communication between a first Bluetooth-enabled device and one or more additional Bluetooth-enabled devices, comprising performing a coupling procedure that causes the Bluetooth Device Address (BD Addr) of said one or more devices with which said first device needs to be able to communicate, to be stored in said first device.

According to one embodiment of the invention when communication is initiated by a first device with a second device the BD Addr of which it has stored, pairing information is exchanged between the two devices.

In one embodiment of the invention the storing of the BD Addrs in the devices being coupled is performed in a non-simultaneous or non-symmetrical manner.

According to one specific embodiment of the invention the coupling procedure is performed via a web server, a web application, or a combination thereof. Thus in accordance with this embodiment of the invention the method comprises providing a server provided, integrally or cumulatively, with separate servers, a web server which is capable of communicating with a database, which hosts a personal web page, wherein said database comprises data suitable to perform coupling between a plurality of Bluetooth-enabled devices. The Bluetooth-enabled device can be of any kind and, in one embodiment of the invention, it is a headset.

In another aspect the invention is directed to a system for performing a coupling between a plurality of Bluetooth-enabled devices, comprising:
A web server;
A database;
a PC or smartphone which is capable of operating a web browser; and
data connection means provided in said PC or smartphone, suitable to connect with a Bluetooth-enabled device and to exchange data with it.

The server may further comprise a GTP server, suitable to convert text to phoneme, a TTS server, suitable to convert text to speech, and software or hardware suitable to compress the audio file generated by the TTS server such as a Vocoder.

The invention also encompasses a headset comprising processing means running software capable to exchange BD Addr data with an external source. In one embodiment of the invention the headset is provided with data connection means suitable to connect to a PC or smartphone.

Also covered by the invention is a method for identifying the BD Addr of a second headset to which the user of a first headset wishes to connect, comprising:
a) saving in the first headset a compressed audio file generated from text representing a voice tag;
b) saving in the first headset a phoneme generated from text representing a voice tag;
c) when the user of the first headset speaks a voice tag, analyzing his speech, comparing it to the phonemes and identifying the phoneme that represents it, optionally playing back to him the audio file associated with said phoneme; and
d) retrieving the BD Addr associated with the identified phoneme.

### BRIEF DESCRIPTION OF THE DRAWINGS

In the drawings:

FIG. 1 schematically shows the architecture of a system according to one embodiment of the invention;

FIGS. 2a-2c schematically show an illustrative example of a web page used by a user to carry out the invention;

FIG. 3 is an illustrative example of the profile creation or editing for the user of the web page of FIGS. 2a-2c; and

FIG. 4 schematically shows the handling of voice tags according to one particular embodiment of the invention.

### DETAILED DESCRIPTION OF THE INVENTION

As explained above the pairing process is essential in order to allow two Bluetooth-enabled devices to communicate between them. The process involves the use of the BD Addr (Bluetooth device address), which is a unique identification of the device, and of a so-called “link key” as well as other pairing information. The pairing process is well known by persons skilled in the art and is described, e.g., in http://www.bluetomorrow.com/about-bluetooth-technology/general-bluetooth-information/bluetooth-pairing.html and in http://en.wikipedia.org/wiki/Bluetooth#Pairing_mechanisms.

The invention takes a novel approach to the creation of the communication channel between Bluetooth devices, by introducing a different process. According to the invention the first step, which hereinafter will be termed “coupling” for the sake of clarity and to avoid confusion with other procedures, involves causing the BD Addr of the first device to be stored in the second device, and the BD Addr of the second device to be stored in the first device, which procedure can be repeated for a plurality of devices.

It should be emphasized that, according to the invention and in sharp contrast to the prior art, the above-mentioned coupling does not have to take place simultaneously, although it may so happen in some instances. In other words, the BD Addr of the first device can be made available to the second device that will, at some later time, read and store it, at which time the first device may or may not already have read and stored the BD Addr of the second device. The only important requirement is that both devices must have completed the coupling procedure before the joint activity of their owners begin.

However, if hardware and/or software arrangements have been made so that the devices can complete the pairing procedure after the device initiating the procedure (the first device) has acquired the BD Addr of the device with which it wants to connect (the second device), then this would satisfy the condition that the coupling procedure be completed, even though the second device is not in possession of the BD Addr of the first device, and all that is described herein with reference to the exchange of both BD Addrs will apply, mutatis mutandis, to the acquisition of the second BD Add only. It should be understood, however, that only the first device, which possesses the BD Addr of a second device, can initiate a communication with the second device. In this case the second device is not able to initiate a communication with the first device.

As will become more easily apparent through the illustrative examples below, the coupling procedure can be performed with a plurality of devices, resulting in a number of BD Addrs being eventually stored in the first device, as well as in additional ones.

Taking as an illustrative (and non-limitative) example throughout this specification a group of motorbike riders, when the owners of the first and the second device meet for a joint tour they need not perform the pairing step of the prior art, because each headset “knows” the other and, therefore, when driving during the tour and wishing to initiate a conversation all that remains to be done is the to complete the pairing process, a procedure that requires about 1 to 2 seconds and does not require the two users to be physically located near each other. According to the prior art the exchange of the pairing information is performed during the pairing operation. In contrast, according to the invention, this exchange is performed as a preliminary step to the conversation, when one coupled device first communicates with the other. In one embodiment of the invention the pairing info is exchanged every time a conversation is initiated, thus saving storage space in the device by not storing pairing information in it. In another embodiment of the invention the pairing info is stored after the first exchange, either for a predetermined period of time or until replaced by other data.

The invention makes it possible for a Bluetooth device to be coupled to any number of other devices and to store for each coupled device its BD Addr, which will permit it to initiate a conversation with it and to exchange a pairing info with it. As will be apparent to the skilled person, when a plurality of devices are coupled it becomes necessary, when initiating a conversation, to select the device with which it is desired to converse. An efficient and convenient way in which this can be performed thanks to the invention is another object of the invention and will be discussed in greater detail hereinafter.

The invention is not limited in any way to any particular coupling method. For instance, coupling can be accomplished by transmitting the BD Addr from the smart phone of the owner of the first device to the smart phone of the owner of the second device, and vice versa, e.g., via SMS, and then downloading it into the headset from the smartphone. Providing software to enable the smartphone to perform such operations is a simple and straightforward matter for skilled persons and, therefore, is not addressed herein in detail, for the sake of brevity.

### Description of an Illustrative System

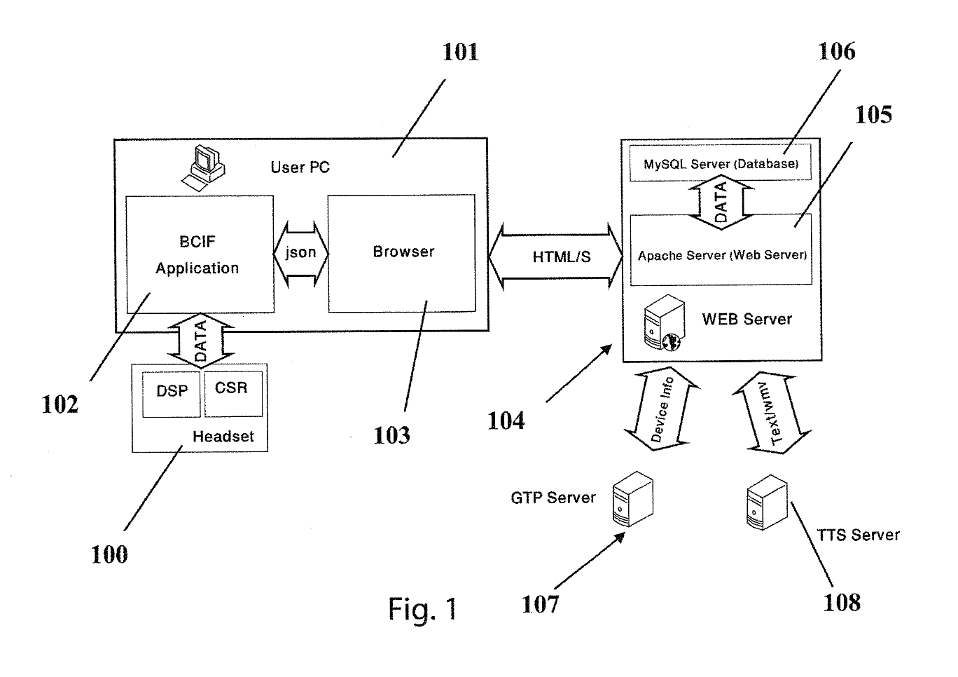

As said, the actual method by which the coupling procedure is performed is not important as long as at the end of the day, i.e., before the joint activity begins, the desired coupling with the other devices has been performed. However, a particularly efficient and useful system and method, which is also an object of the present invention, will be described hereinafter in detail, with reference to a simplified, illustrative example. Referring to FIG. 1, the first user (the term “first user” is used herein only for reasons of convenience, to indicate the user from whose perspective this description is provided) is the owner of a headset 100, also identified by the name “G9 Headset”, which is equipped with DSP capabilities, as well as with a data port that allows to connect it to an external device, such as a PC. Of course, the designation “G9 Headset” only refers to a specific, illustrative example and any other suitable device can be employed in conjunction with the invention. In this example, headset 100 is connected to a PC 101, but as explained above it could be connected to any other alternative device, such as a smart phone. PC 101 runs software 102 to communicate with the headset 100, as well as a browser 103. Browser 103 is connected to a Web server 104, which may be housed in a single device or maybe an assembly of different subsystems and servers. Server 104 runs a Web server 105 (which in the example shown is an Apache server), connected to a database 106, which in the example given is a MySQL server. Server 104 also comprises GTP server 107, which is equipped with software suitable to convert text to phoneme, and a TTS server 108, which is equipped with software suitable to convert text to speech. Of course, the simplified diagram of FIG. 1 only illustrates a possible structure of the system, and other alternative systems will be easily devised by the skilled person.

Web server 105 hosts the website used by the first user to initiate the coupling process, as well as to perform additional activities that will become apparent from the description to follow. All information uploaded to this website is stored, in this illustrative example, in the MySQL server 106.

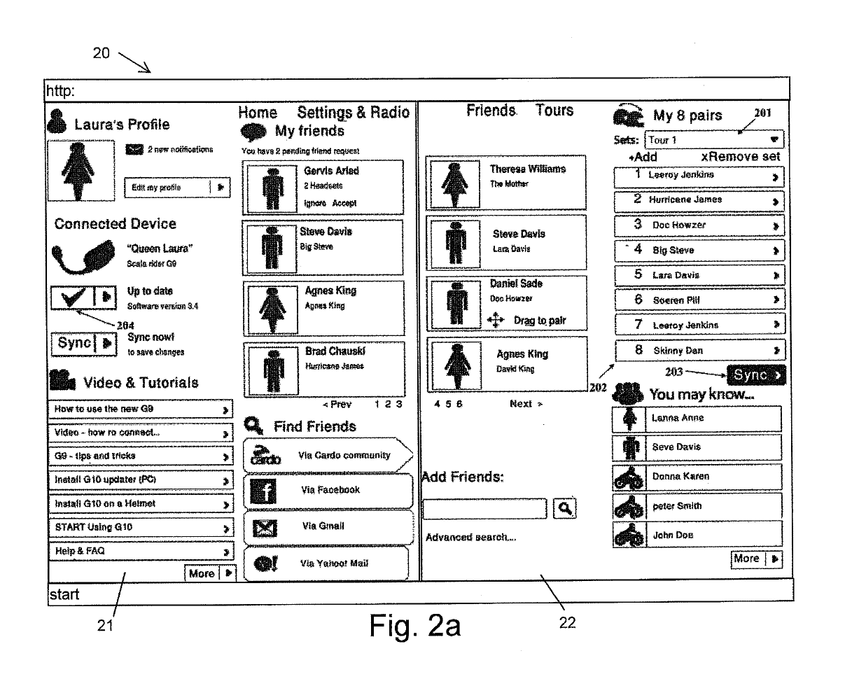

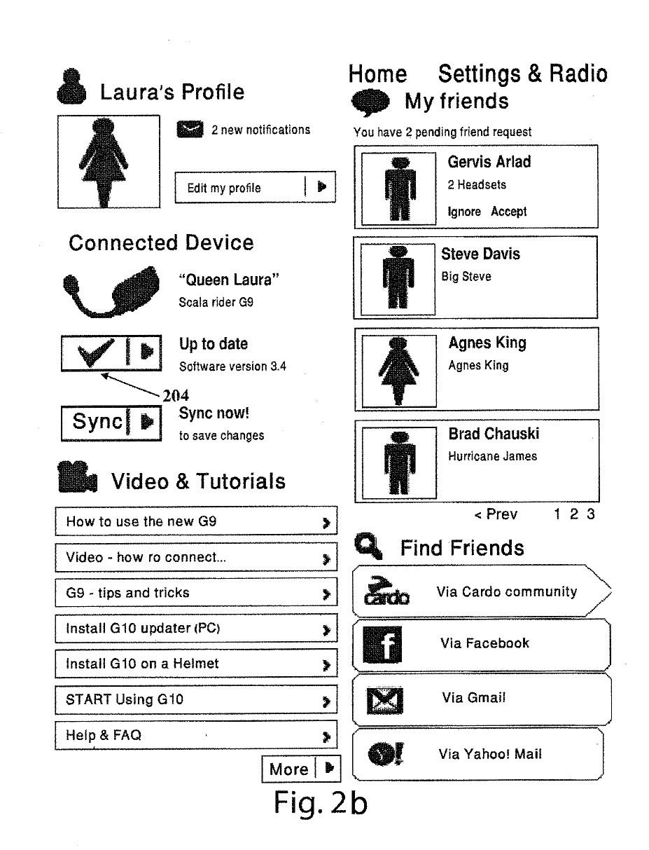

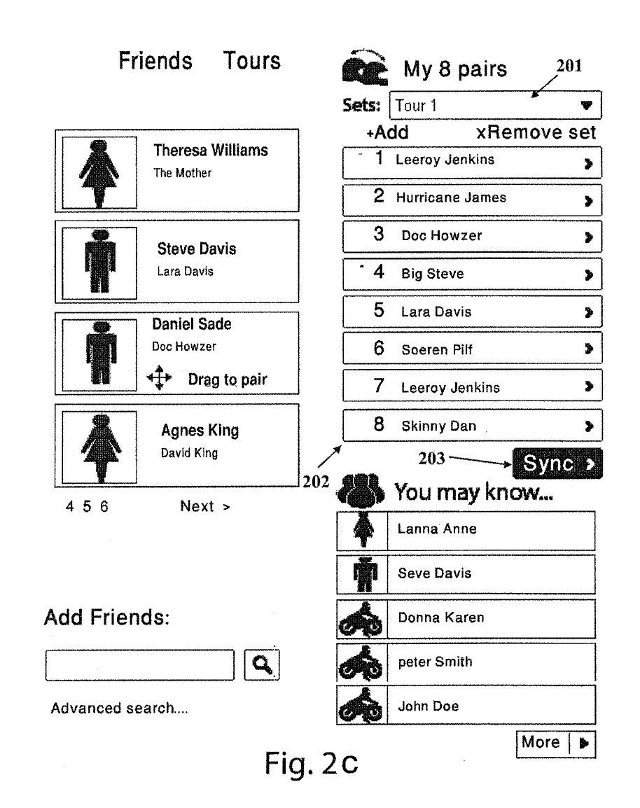

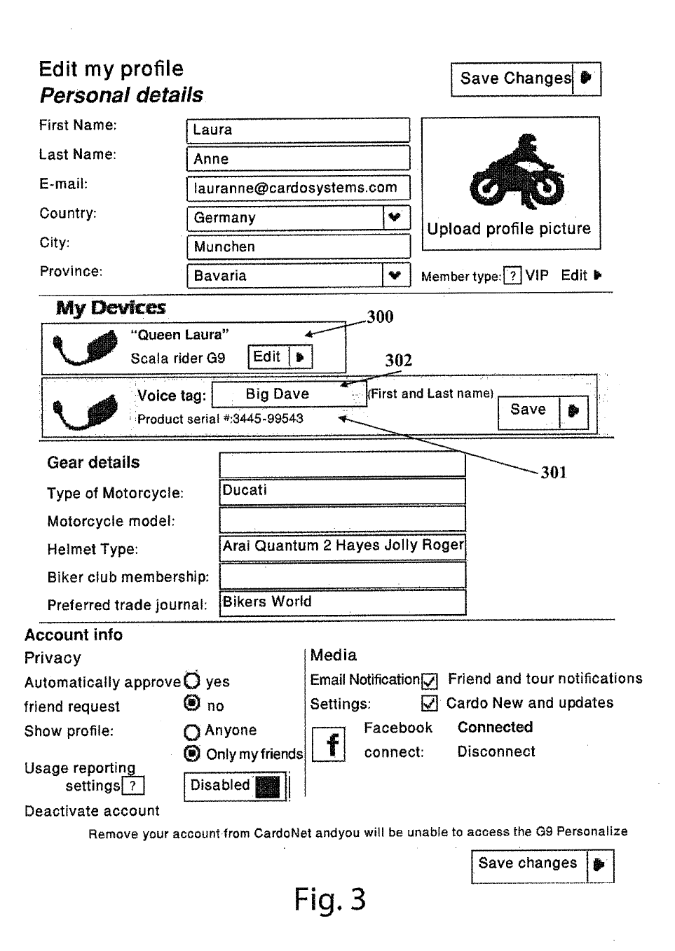

Looking now at FIGS. 2a-2c, an example of a webpage through which the invention is performed is shown. FIG. 2a schematically indicates a web page 20, wherein part 21 of the webpage is shown in FIG. 2b and part 22 of the webpage is shown in FIG. 2c. This webpage belongs to a user named Laura (the “first user” in this example) and she performs the various activities that will be described hereinafter. Initially, to set up the webpage Laura has to create a profile, an example of which is shown in FIG. 3, which contains her details, the details of the device 300 she owns, as well as its BD Addr 301 and the voice tag 302 by which she wants the headset to be identified, which is provided as a text string.

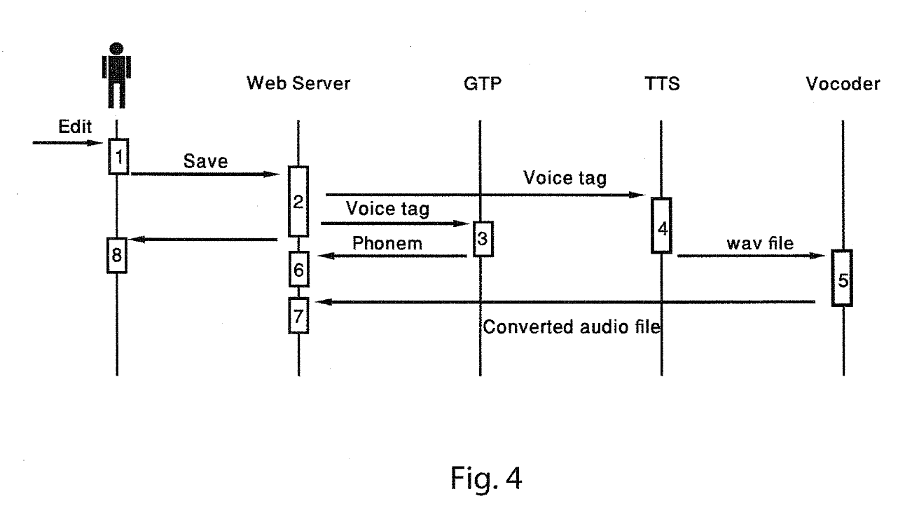

When the user profile is created or edited a sequence of activities takes place, as shown in FIG. 4. This process is important to the understanding of the operation of the system, and therefore will be explained in more details. The voice tag 302 of FIG. 3 is eventually used to identify the headset that is being called in an environment in which the headset is coupled with more than one device. According to the invention a unique approach is taken, which results in the following steps:
(i) the voice tag 302 is sent to the GTP (Grapheme to Phoneme) server, which converts it to phoneme;
(ii) the voice tag 302 is also sent to the TTS (Text-To-Speech) server, which converts it to speech;
(iii) the audio (e.g., a PCM, MP3 or way) file generated from the text by the TTS server is sent to a suitable engine, e.g., a vocoder, which compresses it;
(iv) the phoneme generated by the GTP server and the compressed audio file generated by the vocoder or other compression engine are both stored by the Web server in the database (106 in FIG. 1).

### Description of Coupling Procedures

Returning now to FIGS. 2a-2b, the webpage may function as a social community and can perform all conventional activities carried out in such communities, such as receiving and sending friend requests, chatting, etc. The following, however, will describe the creation of the list of headsets with which Laura will be able to pair on the ground, after performing the coupling procedure described hereinabove. It should be understood that multiple lists may be created and saved in order to be used in different occasions. For example, separate lists can be created for different tours, and the list of FIG. 2c refers to Tour 1, as indicated in the figure at 201. In this illustrative example Laura's device is capable of coupling with 8 other devices, but this number is merely dictated by the memory and hardware characteristics of her headset, and it should be understood that there is no actual limitation on the number of headsets with which coupling can be undertaken, given the appropriate hardware. The list of people with which Laura has performed coupling is shown at 202. It should be understood that the friends appearing in the list at 202 may in turn be coupled with any number of different people who are not in Laura's list, and the lists of the participants do not have to be identical.

In this particular example Laura can only include in her 202 list people (and hence devices) for which data is available in database 106 of FIG. 1. If the relevant data is not available no coupling can take place. Once Laura has selected the eight names and her headset is connected to the webpage through her PC 101 (or, as said, through an alternative device such as a smart phone) she can synchronize it, e.g., by clicking the sync button 203 or 204, upon which browser 103 sends requests to server 105 to send it the addresses of the phonemes and audio files and BD Addr of each of the members of the list 202. Once the data is received the application 102 initiates the synchronization process by downloading the phonemes, BD Addresses and the audio files and then uploading them to headset 100. Of course, in order to complete the process each of the friends in Laura's list 202 must also synchronize his or her headset to obtain Laura's data and upload it to his or her headset, unless alternative hardware and/or software means have been provided in the device to enable pairing using only the BD Addr of Laura's device, as discussed above. Once this procedure is completed Laura is coupled with all the headsets in her list and is ready to initiate communication on the ground.

It should be understood that, while specialized software can be used to communicate between the web site and the device through a PC, this is just one illustrative mode of operation, since communication can be achieved in any other suitable way, e.g., via USB using standard communication protocols.

### Initiation of Communication

The specific embodiment of the invention described herein takes advantage of a novel approach to utilizing voice recognition, as will be further discussed hereinafter. However, it should be understood that the invention is in no way limited to using such novel approach, and it can conveniently employ normal voice-recognition methods to identify the headset being called, e.g., by providing suitable DSP capabilities in the headset such that, for instance, when the owner speaks the name of the user he wants to contact his voice is analyzed and compared against a prerecorded sample of the names of the various users available, to select the right connection. Other alternative methods known in the art can also be used in conjunction with the invention.

The invention, however, allows as said, to exploit a novel approach according to which the compressed audio file created in the vocoder of FIG. 4 is stored, together with the phoneme that represents it, in the headset. When the user speaks the name of the person with whom he wants to connect, his speech is analyzed against the phoneme and then the prestored audio file is decoded (de compressed) and played back to him to verify the correctness of the selection.

As seen in FIG. 2b, the system according to the invention permits to perform other important activities, such as to update the firmware of the device or other software uploaded to it, as shown at 204.

All the above description of the system, the method to operate it and the devices using them has been provided for the purpose of illustration and is not intended to limit the invention in any way. Many modifications and additions can be made to the system and to the methods to trigger and start the coupling process, and many different web and other interfaces can be devised to carry out the invention, all without exceeding the scope of the claims.

1. A method for permitting communication between a first Bluetooth-enabled device and one or more additional Bluetooth enabled devices, the method comprises performing of a coupling procedure that causes storage at said first device of a Bluetooth Device Address (BD Addr) of each of the one or more devices with which said first device needs to be permitted to communicate.

2. The method of claim 1, wherein when a communication is initiated by said first device with another device whose BD Addr is stored at said first device, pairing information is exchanged between said two devices.

3. The method of claim 1, wherein the storage of the BD Addresses in the devices being coupled is performed in a non-simultaneous or non-symmetrical manner.

4. The method of claim 1, wherein the coupling procedure is performed via a web server, a web application, or a combination thereof.

5. The method according to claim 1, comprising providing a server provided, integrally or cumulatively, with separate servers, a web server which is capable of communicating with a database, which hosts a personal web page, wherein said database comprises data suitable to perform coupling between a plurality of Bluetooth-enabled devices.

6. The method according to claim 1, wherein the Bluetooth-enabled device is a headset.

7. A system for performing a coupling between a plurality of Bluetooth-enabled devices, comprising:
A web server;
A database;
a PC or smartphone which is capable of operating a web browser; and
data connection means provided in said PC or smartphone, suitable to connect with a Bluetooth-enabled device and to exchange data with it.

8. A system according to claim 7, wherein the server further comprises a GTP server, suitable to convert text to phoneme, a TTS server, suitable to convert text to speech, and software or hardware, suitable to compress the audio file generated by the TTS server.

9. A headset comprising processing means running software capable to exchange BD Addr data with an external source.

10. The headset of claim 9, which is provided with data connection means suitable to connect to a PC or smartphone.

11. A method for identifying the BD Addr of a second headset to which the user of a first headset wishes to connect, comprising:
a) saving in the first headset a compressed audio file generated from text representing a voice tag;
b) saving in the first headset a phoneme generated from text representing a voice tag;
c) when the user of the first headset speaks a voice tag, analyzing his speech, comparing it to the phonemes and identifying the phoneme that represents it, optionally playing back to him the audio file associated with said phoneme; and
d) retrieving the BD Addr associated with the identified phoneme.

12. The method of claim 11, wherein the audio file is a wav file or PCM file.
